(19) United States
(12) Patent Application Publication
(10) Pub. No.: US 2007/0031612 A1
(43) Pub. Date: Feb. 8, 2007

(54) Method for producing cellulose ester film and liquid crystal display using the same

(75) Inventor: Kazuyuki Shimizu, Akashi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/495,633

(22) Filed: Jul. 31, 2006

(30) Foreign Application Priority Data
Aug. 3, 2005 (JP) JP2005-225959

(51) Int. Cl. C09K 19/00

(52) U.S. Cl. 428/1.1; 428/1.31

(57) ABSTRACT

A method of producing of cellulose ester film, comprises steps of casting a dope containing a cellulose ester and an additive for reducing a retardation onto a support to form the film, peeling the film from the support, a stretching process of stretching the peeled film by a tenter, post- drying the stretched film and winding up the dried film. A stretching/shrinking ration (%) of the film in a transporting direction MD and a stretching/shrinking ratio (%) of the film in a traversal direction TD are satisfy the following relation in the course after peeling the film from the support until winding up the film; −20%≦MD+TD≦0%.

This application is based on Japanese Patent Application No. 2005-225959 filed on Aug. 3, 2005, in Japanese Patent Office, the entire content of which is hereby incorporated by reference.

### BACKGROUND OF THE INVENTION

The present invention relates to a method for producing film applicable for producing an optical cellulose film to be used for a protective film of a polarizing plate of a liquid crystal display or an optical compensation film and a liquid crystal display using the same.

In this specification, the dope cast on an endless belt and dried and made into a state of layer capable of being peeled off from the endless belt is referred to as the “film”.

Liquid crystal display which is widely used in recent years as a display element is constituted by a liquid crystal cell composed of a pair of substrates arranged on both sides of a liquid crystal layer and a pair of polarizing plate arrange on both sides of the liquid crystal cell in a state of crossing at right angle. For driving the liquid crystal display, various driving modes such as a twisted nematic mode (TN), a vertically aligned mode (VA) and an in-plane switching mode (IPS) are proposed. In the case of the IPS mode, it has been known that the difference of the double refractive indexes in a state of OFF and ON of the electric field application is small and the viewing angle is made wider since the liquid crystal molecules are mainly rotated in the plane parallel with the surface of the substrate.

In the IPS mode, the liquid crystals homogeneously oriented in the horizontal direction and two polarizing plates are used, which are arranged so that the transmission axes of them are crossed at right angle in the direction of top and bottom, and right and left of the front of the imaging screen, and sufficient contrast can be obtained when the image is obliquely viewed in the direction of the top and bottom or right and left. Contrary to that, the contrast is lowered when the image is obliquely viewed in the direction of 45° because the angle made by the transmission axes of the two polarizing plates seems out of 90° from such the position relation so that the transmitted light is double refracted and light leaking is resulted. Namely, in the polarizing plate using usual cellulose ester film as the protective film, a problem is caused that the viewing angle is narrowed by the double refractivity of the film.

Japanese Patent O.P.I. Publication No. 2005-99097 proposes an optical film in which the retardation in the plane direction and that in the thickness direction are reduced to not more than 10 nm.

In Japanese Patent O.P.I. Publication No. 2005-99097, an amorphous thermoplastic resin such, as a saturated norbonene type resin is used as the basic material of the optical film. On the other hand, it is advantageous for the industrial production of the polarizing plate if the function of the protective film can be satisfied by the cellulose ester film mainly used for the polarizing plate protecting film because any improvement in the production process of the polarizing plate is almost not necessary. Patent Document 1, however, does not suggest any use of cellulose ester type film.

### SUMMARY OF THE INVENTION

The invention is attained on the above background. An object of the invention is to provide a cellulose ester type optical film having low double refractivity.

For attaining the above object, the invention described in Item 1 is a method for producing a cellulose ester film comprising the steps of casting a dope containing cellulose ester and an additive for reducing the retardation onto a support to form the film, peeling the film from the support, stretching the peeled film by a tenter, post-drying for frying the stretched film and winding up the dried film, wherein the stretching/shrinking ratio in percent of the film in the transporting direction MD and that of the film in the traversal direction TD are satisfy the following relation in the course between the peeling off to the winding up of the film;
−20%≦MD+TD≦0%.

In the invention of Item 1, MD and TD are each expressed by the following expression:
MD=(Transporting rate at the time of winding up/Transporting rate on the support−1)×100%
TD=(Film width at the time of winding up/Film width just before peeling from the support−1)×100%

The additive for reducing the retardation is referred hereinafter to as the retardation reducing agent.

Incidentally, in the film production process, an edge of a film is removed by a slitting process. In this case, the stretching/shrinking ratio in percent of the film in the traversal direction TD is represented as the following:
TD=((Sum of Film width at the time of winding up and Width of a slit portion after drying)/Film width just before peeling from the support−1)×100%

The invention described in Item 2 is the method described in Item 1, wherein the MD and TD satisfy the following relation;
−10%≦MD−TD≦10%.

The invention described in Item 3 is the method described in Item 1 or 2, wherein the MD and TD satisfy the following relation;
−5%≦MD≦5%, and −5%≦TD≦5%.

The invention described in Item 4 is the method described in any one of Items 1 to 3, wherein the stretching/shrinking ratio in percent of the film in the transporting direction MD and that of the film in the traversal direction TD are adjusted to satisfy the following relation;
0≦Ro≦3, and −3≦Rt≦3

where Ro represents a in-plane retardation (nm) of the cellulose ester film, and Rt represents a width direction retardation (nm) of the cellulose ester film.

The invention described in Item 5 is the method described in any one of Items 1 to 4, wherein the reducing rate of remaining solvent is from 2 to 5% per second when the amount of the remaining solvent in the film on the support is lowered from 400% to 100%.

The invention described in Item 6 is the method described in any one of Items 1 to 5, wherein the amount of solvent remaining in the film at the time of peeling off of the film from the support is from 60 to 125%.

The invention described in Item 7 is the method described in any one of Items 1 to 6, wherein the tension applied for peeling off the film from the support is from 80 to 200 N/m.

The invention described in Item 8 is the method described in any one of Items 1 to 7, wherein the amount of the remaining solvent at the time of beginning the stretching is from 10 to 40%.

The invention described in Item 9 is the method described in any one of Items 1 to 8, wherein a temperature at the stretching step is from 110 to 160° C. and a stretching ratio of the film is from 1 to 12%.

The invention described in Item 10 is the method described in Item 9, wherein the method further has a relaxing step for relaxing the film and a relaxing ratio of the film in the relaxing step is from 1 to 6%.

The invention described in Item 11 is the method described in any one of Items 1 to 10, wherein a temperature and a drying time in the post-drying step are each from 100 to 150° C. and from 6 to 30 minutes, respectively.

The invention described in Item 12 is the method described in any one of Items 1 to 11, wherein the additive contains an acryl type polymer having a weight average molecular weight of from 500 to less than 3,000.

The invention described in Item 13 is the method described in any one of Items 1 to 12, wherein the additive contains an acryl type polymer having a weight average molecular weight of from 5,000 to less than 30,000.

The invention described in Item 14 is the method described in any one of Items 1 to 13, wherein a thickness of the cellulose ester film is from 35 to 85 μm.

The invention described in Item 15 is a liquid crystal display having a liquid crystal cell driven in IPS mode and a pair of polarizing plates arranged on both sides of the liquid crystal cell for crossing at right angle, wherein the cellulose ester film produced by the method described in Item 1 is provided on the liquid crystal cell side of at least one of the polarizing plates.

According to the invention described in Item 1, the film having low double refractivity can be provided even when cellulose acetate is used as the raw material of the film. As the retardation reducing agent, for example, the acryl type polymer described in Items 12 and 13 can be used.

The thin cellulose ester film superior in the optical isotropy such as that described in Item 14 can be produced by setting the producing processed according to description of Items 2 to 11.

By the liquid crystal display of Item 15, the light leaking in the oblique direction can be considerably reduced and a wide viewing angle can be obtained.

### BRIEF DESCRIPTION OF THE DRAWINGS

FIG. 1 shows a schematic side view of film producing equipment for embodying the producing method of cellulose ester film of the invention.

FIG. 2 shows a schematic plane view of the stretching apparatus (tenter) in the equipment shown in FIG. 1.

### DETAILED DESCRIPTION OF THE PREFERRED EMBODIMENT

The invention is concretely described below.

As cellulose ester which is the main ingredient of the cellulose ester film of the present invention, cellulose triacetate, cellulose diacetate, cellulose acetate butyrate, cellulose acetate propionate, etc. may be listed.

As a solvent for cellulose ester, for example, lower alcohol, such as methyl alcohol, ethyl alcohol, n-propyl alcohol, isopropyl alcohol, and n-butyl alcohol, and low-grade aliphatic chloride hydrocarbons, such as cyclohexane, dioxanes, methylene chloride can be used.

After dissolving, the resultant solution is taken out from a container while cooling, or extracted with a pump etc. from the container and cooled by a heat exchanger etc., and then the solution is subjected to film production.

Other than cellulose ester and the solvent, a UV absorber and retardation reduction agent are included.

As a UV absorber, from the point of deterioration prevention for a liquid crystal, a UV absorber excellent in the absorbing power for ultraviolet rays having a wavelength of 370 nm or less is preferably used, and from the point of excellent liquid crystal display capability, a UV absorber absorbing little visible ray having a wavelength of 400 nm or more as far as possible is preferably used. As a UV absorber generally used, an oxi-benzophenone type compound, a benzotriazole type compound, a salicylate type compound, a benzophenone type compound, a cyanoacrylate type compound, a nickel complex salt type compound, etc. may be listed, for example, however, it is not limited to these.

Next, a retardation reducing agent is explained.

The retardation of a cellulose ester film appears as the sum of the retardation of cellulose ester itself and the retardation of additive itself. Therefore, an additive to reduce the retardation of a cellulose ester film is an additive which disturbs the orientation of cellulose ester and is not easily oriented itself and/or having a small polarizability anisotropy. As an additive for disturbing the orientation of cellulose ester, an aliphatic type compound is more desirable than an aromatic compound. As a concrete retardation reduction agent, an acrylic type polymer and a polyester type polymer can be used.

(Acryl Type Polymer)

In the invention, the acryl type polymer is a polymer or a copolymer synthesized from a monomer such as acrylic acid or acrylate having no aromatic ring in the molecular thereof.

Examples of the acrylate monomer having no aromatic ring include methyl acrylate, ethyl acrylate, i- or n-propyl acrylate, n-, i-, s- or t-butyl acrylate, n-, i- or s-pentyl acrylate, n- or i-hexyl acrylate, n- or i-heptyl acrylate, n- or i-octyl acrylate, n- or i-nonyl acrylate, n- or i-myristyl acrylate, 2-ethylhexyl acrylate, c-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, 2-methoxyethyl acrylate and 2-ethoxyethyl acrylate, and the above-mentioned in each of which the acrylate is replaced by methacrylate.

In the case of that the acryl type polymer is a copolymer, it is preferable that the copolymer composed of a monomer component X having a hydrophilic group and a monomer component Y having no hydrophilic group and a mole ratio of X Y is from 1:1 to 1:99. Without this range, the degradation of the polarization element is considerably increased when the film is used in-the polarization plate. The content of the acryl polymer is preferably from 1 to 20% by weight of the cellulose ester.

The acryl type polymer having a weight average molecular weight of from 500 to 10,000 displays good compatibility with the cellulose ester and is not volatiled during the film formation. An acryl type polymer having an acryl type polymer as a side chain is gives excellent transparency and extremely low moisture permeability to the cellulose ester film when the molecular weight of such the polymer is from 500 to 5,000. The film shows superior properties for the polarization plate protective film.

The above acryl type polymer can be synthesized referring the method described in Tokkai 2003-12859.

As a polyester type polymer used as a retardation reduction agent, a polyester expressed with the following general formula (1) or (2), for example is desirable.
B₁-(G-A-)ₘG-B₁ General formula (1)
B₂-(A-G-)ₙA-B₂ General formula (2)

In Formula 1 and 2, B₁ is a monocarboxylic component, B₂ is a monoalcohol component, G is a di-valent alcohol component and A is a di-basic acid component; the polyester is synthesized by these components. The components B₁, B₂, G and A are each characterized in that these components contain no aromatic ring, and m and n are each represents repeating number.

As the carboxylic acid represented by B₁, a known aliphatic or alicyclic monocarboxylic acid can be used without any limitation.

Though the followings can be described as examples of preferable monocarboxylic acid, the invention is not limited to them.

As the aliphatic monocarboxylic acid, an aliphatic acid having a straight chain or a branched chain each containing from 1 to 32 carbon atoms is preferably applied. The number of the carbon atoms is preferably from 1 to 20 and more preferably from 1 to 12. The inclusion of acetic acid is, preferable because the compatibility with the cellulose ester is increased and mixing of acetic acid and another monocarboxylic acid is also preferable.

Examples of preferable monocarboxylic acid include a saturated aliphatic acid such as formic acid, acetic acid, propionic acid, butylic acid, valeric acid, capronic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachinic acid, behenic acid, lignocelic acid, cerotic acid, heptaconic acid, montanic acid, melicic acid and laccelic acid, and a unsaturated aliphatic acid such as undecylenic acid, oleic acid, sorbic acid, linolic acid, linolenic acid and arachidonic acid.

As the alcohol component represented by B₂, a known alcohol can be applied without any limitation. For example, a saturated or unsaturated aliphatic alcohol having a straight or branched chain containing from 1 to 32 carbon atoms can be applied. The number of the carbon atoms is preferably from 1 to 20 and more preferably from 1 to 12.

As the di-valent alcohol represented by G, the followings can be cited but the invention is not limited to them. Examples of the di-valent alcohol include ethylene glycol, diethylene glycol, 1,2-propylene glycol, 1,3-propylene glycol, 1,2-butylene glycol, 1,3-butylene glycol, 1,4-butylene glycol, 1,5-pentanediol, 1,6 hexanediol, 1,5-pentylene glycol, diethylene glycol, triethylene glycol and tetraethylene glycol. Among them, ethylene glycol, 1,2-propylene glycol, 1,3-propylene glycol, 1,2-butylene glycol, 1,3-butylene glycol, 1,4-butylene glycol, 1,4-hexandiol, diethylene glycol and triethylene glycol are preferable, and 3-propylene glycol, 1,4-butylene glycol, 1,6-hexanediol and diethylene glycol are further preferably applied.

As the di-basic acid(dicarboxylic acid) represented by A, aliphatic and alicyclic di-basic acids such as malonic acid, succinic acid, glutaric acid, adipic acid, pimelic acid, suberic acid, azelaic acid, sebacic acid, undecanedicarboxylic acid and dodecanedicarboxylic acid are preferably applicable. Particularly, at least one selected from ones having from 4 to 12 carbon atoms is used. Two or more kinds of the carboxylic acid may be used in combination.

m and n are each the repeating number which is preferably from 1 to 170.

As another example of a polyester type polymer used as a retardation reduction agent, a polyester expressed with the following general formula (3) or (4), for example is desirable.
B₁-(G-A-)ₘG-B₁ General formula (3)
B₂-(A-G-)ₙA-B₂ General formula (4)

In Formula (3) and (4), B₁ is a monocarboxylic component, B₂ is a monoalcohol component, G is a di-valent alcohol component having carbon atoms of 2 to 12 and A is a di-basic acid component having carbon atoms of 2 to 12; the polyester is synthesized by these components. The components B₁, B₂, G and A are each characterized in that these components contain no aromatic ring, and m and n are each represents repeating number. B₁ and B₂ are synonymous with B₁ and B₂ in the above-mentioned general formula (1) or (2), and B-2. G and A are an alcoholic compositions having carbon atoms of 2-12 and a di-base acid composition having carbon atoms of 2-12 in G and A in the above-mentioned general formula (1) or (2).

The weight average molecular weight of the polyester is preferably not more than 20,000 and more preferably not more than 10,000. The polyester having a weight average molecular weight of from 500 to 10,000 shows good compatibility with the cellulose ester and is not evaporated in the film forming process.

The condensation polymerization of the polyester is carried out by an ordinary method. For example, the polyester can be easily synthesized by a method by directive reaction of the di-basic acid with the glycol, a thermally melting condensation method by polyesterization reaction or ester-exchanging reaction of the di-basic acid or its alkyl ester such as methyl ester of the di-basic acid with the glycol, or a method by dehydrohalogenation reaction of a acid chloride of such the acid with the glycol. The polyester having a weight average molecular weight not so large is preferably synthesized by the direct reaction method. The polyester having a molecular weight distribution rising in the low molecular weight side shows very high compatibility with the cellulose ester so that the cellulose ester film having low moisture permeability and high transparency can be obtained. A known method can be applied without any limitation for controlling the molecular weight. For example, the molecular weight can be controlled under a suitable reacting condition by controlling the adding amount of a mono-valent acid or alcohol in a method for blocking the terminal of the molecular by the mono-valent acid or the mono-valent alcohol. In such the case, the use of the mono-valent acid is preferable from the viewpoint of the stability of the polymer. For the acid, ones which are difficultly distillated out from the system during the polymerization-condensation reaction and easily distillated out after the reaction such as acetic acid, propionic acid and butylic acid are selected. These acids may be used in a mixed state. In the case of the direct reaction, the molecular weight can be controlled by stopping the reaction suitable timing according to the amount of water distillated out from the system during the reaction. Moreover, the control can be carried out by biasing the charging mole number of the glycol or the di-basic acid or by controlling the reaction temperature.

It is desirable to contain the polyester expressed with the general formula (1) or (2) in 1-40% by mass for cellulose ester, and it is desirable to contain the polyester expressed with a general formula (3) or (4) in 2-30% by mass. Especially, it is desirable to contain 5-15% by mass.

As a retardation reduction agent other than above, a retardation reduction agent and an optical anisotropy regulator described in Japanese Patent O.P.I. Publication No. 2005-154764, an acryl type polymer described in Japanese Patent O.P.I. Publication No. 2003-12859, a phosphate ester compound described in Japanese Patent O.P.I. Publication No. 2004-315605, a styrene oligomer and a benzyl methacrylate oligomer described in Japanese Patent O.P.I. Publication No. 2005-105139, a polymer of a styrene type monomer described in Japanese Patent O.P.I. Publication No. 2005-105140, an ester compound of a diglycerol type polyvalent alcohol and a fatty acid described in Japanese Patent O.P.I. Publication No. 2000-63560, an ester or an ester compound of a sugar alcohol of hexose described in Japanese Patent O.P.I. Publication No. 2001-247717, a phosphoric acid tri aliphatic alcohol ester compound described in Japanese Patent O.P.I. Publication No. 2004-315613, a compound described in Japanese Patent O.P.I. Publication No. 2005-41911 may be listed.

Further, a retardation reduction agent can be fount by the following methods. Firstly, a dope solution in which a cellulose ester is dissolved in methylene chloride is subjected to a film production on a glass plate, and is dried at 120° C./15 min. so as to form a cellulose ester film having a thickness of 80 μm. The retardation in a thickness direction of the cellulose ester film is Rt₁. Next, a dope solution is prepared by adding an additive by 10% by weight for a cellulose ester and by dissolving them in methylene chloride, and then a cellulose ester film having a thickness of 80 μm is prepared with the dope by the same way with above. The retardation in a thickness direction of the cellulose ester film is Rt₂. When the above retardations Rt₁ and Rt₂ satisfy the condition that Rt₂<Rt₁, the additive added in the cellulose ester is a retardation reduction agent.

Incidentally, in the dope, a plasticizer, an antioxidant, a dye, a heat stabilizer, an antistatic additive, a flame retarder, a lubricant, an oily agent, etc. may be added.

In the embodiment, a dope prepared by dissolving cellulose ester is cast on a support (casting process) and then peeling off the formed film from the support (peeling process), and the peeled film is stretched (stretching process), dried (Drying process) and wound up in a rolled state (winding process to obtain a cellulose ester film.

The above processes are described below referring the drawing. The cellulose ester film producing equipment includes a support 1 constituted by a rotatable metal endless belt, a die 2 for casting a dope as the raw solution of the cellulose ester film, a peeling roller for peeling off a web W formed on the support 1 by the die 2, a tenter 4 for conveying the film F peeled from the support while stretching the film F in the traversal direction, a drying apparatus for drying the film while transporting the film via plural transporting rollers 6, and a winding up roller 8 for winding up the dried cellulose ester film F.

In this producing processes, the drying condition and the transporting tension are controlled so that the stretching/shrinking ratio of the film in the transporting direction MD in percent and the stretching/shrinking ratio of the film in the traversal direction TD in percent satisfy the following conditions in the course of from the peeling the film F from the support to the winding up by the winding roller 8.
−20%≦MD+TD≦0%
−10%≦MD−TD≦10%

The condition of (−20%≦MD+TD≦0%) should be satisfied for obtaining desired optical property by reducing the retardation Rt in the thickness direction. In the case of the protective film for the polarizing plate of the display driven in the IPS mode, Rₜ is preferably from −10 nm to 10 nm, and more preferably from −5 nm to 5 nm. When the value of (MD+TD) exceeds 0%, the retardation Rₜ in the thickness direction cannot be satisfactorily reduced. The condition of −5%≦MD+TD≦5% is more preferable.

The condition of (−10%≦MD−TD≦10%) should be satisfied for improving the polarizing ability of the film by reducing the difference between the refractive index (nₓ) in the optical slow axis direction in plane and the refractive index (n_{y}) in the direction crossing at right angle with the above direction so as to lower the in-plane retardation R₀. In the case of the protective film for the polarizing plate of the display driven in the IPS mode, and the R₀ is preferably approximately 0 nm. When the value of (MD−TD) is without the above range, the difference between the stretching ratio in the film transporting direction and that in the traversal direction is increased in the course of from the peeling off to the winding up. As a result of that, the molecular orientation state in the final product of the cellulose ester film is largely different in the transporting direction and the traversal direction so that the difference between the refractive indexes nₓ and n_{y} becomes large and the in-plane retardation R₀ is raised. The value being within the range of (−5%≦MD−TD≦5%) is more preferable.

Incidentally, it may be preferable that the stretching/shrinking ratio of the film in the transporting direction MD (%) and the stretching/shrinking ratio of the film in the traversal direction TD (%) satisfy the following relation;
−5%≦MD≦5%
−5%≦TD≦5%

Here, the stretching/shrinking ratio of the film in the transporting direction MD can be adjusted by adjusting a remaining amount of solvent when peeling a film from a support or the tension of the film in the transporting direction right after peeling. Further, it can be possible to adjust it finely by adjusting a temperature or a tension in the post drying process after the tenter process. On the other hand, the stretching/shrinking ratio of the film in the transverse direction TD can be adjusted by adjusting a tneter stretching ratio, a relaxing ratio or a tenter temperature. Further, it may be possible to adjust it by adjusting a remaining amount of solvent when peeling a film from a support, the tension of the film in the transporting direction right after peeling, a temperature or a tension in the post drying process after the tenter process.

The thickness of the final product of from 35 to 85 μm is usually preferable and from that of 40 to 80 μm is more preferable. When the thickness is too thin, the stiffness of the film becomes low and the handling ability of which tend to be inferior. When the thickness is too thick, the display becomes thick and the portability of which is tend to be spoiled. The thickness of the film is preferably controlled by controlling the concentration of the dope, the transporting amount of the dope by the pump, the slit width of the die, the extruding pressure in the die and the speed of the casting support. For making uniform the thickness, a means is preferable, in which the thickness is preferably controlled by feedbacking programmed information to the apparatus in each of the processes.

The processes are each described below.

(Casting Process)

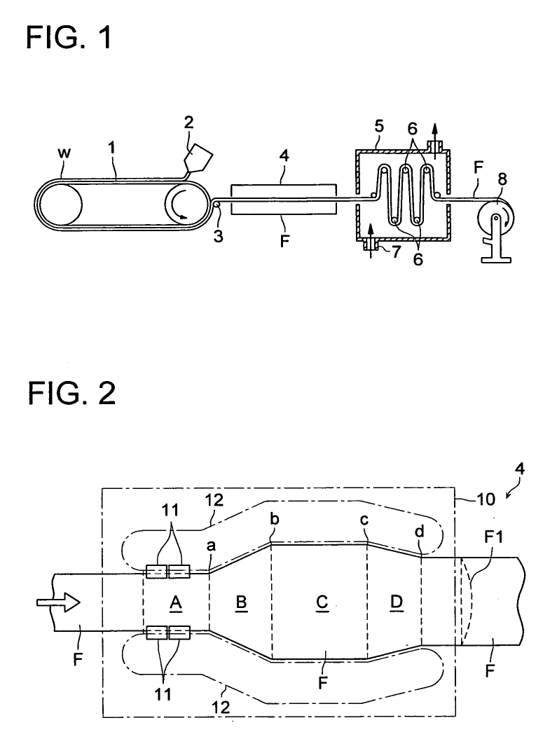

In the above cellulose ester film producing equipment, the dope as the raw material solution of the cellulose ester film is cast by through the casting die 2 onto the rotating endless belt support 1. For the support 1 in the casting process, an endless belt support shown in FIG. 1 or a drum shaped support is used, which are made from stainless steel and have mirrored surface.

In the cellulose ester film producing method, it is preferable for lowering the in-plane orientation degree that the dope layer or web being dried on the support 1 is dried in a remaining solvent reducing rate, hereinafter referred to as drying rate, of from 2 to 5% by weight per second during the period in which the remaining solvent amount in the web is within the range of from 400% to 100% by weight. The drying rate of from 3 to 4.5% by weight per second is more preferable.

The remaining solvent amount in the film of the invention is defined by the following expression.
Remaining solvent amount (weight-%)={(M−N)/N}×100

In the above:

M: Weight of a film at an optional time N: Weight of the film after dried at 110° C. for 3 hours

(Peeling Process)

The web W formed on the support 1 is peeled off by the peeling roller 3 after making approximately one circuit.

When the remaining solvent amount in the web W, hereinafter referred to as remaining solvent amount at peeling point, is excessively large, the peeling is difficultly carried out and when the web is excessively dried, a part of the web is peeled in the course of the drying. It is preferable to peel the web after dried on the support 1 so that the remaining solvent amount at the peeling point becomes within the range of from 60 to 125%. Thus the in-pale retardation can be held at a low level and the surface quality can be improved. The remaining solvent amount at the peeling point is more preferably from 80 to 115%.

When the remaining solvent amount at the peeling point is nigher than the above, the web is excessively soft and the flatness of the web is spoiled at the occasion of peeling and wrinkles and vertical lines tend to be caused. Therefore, the remaining solvent amount at the peeling point is decided on the balance of the economical speed and the product quality. In the invention, the tension for peeling the film from the support 1 is set at a tension of from 80 to 200 N/m. When the tension is too high, winkles tend to be caused on the occasion of the peeling. Contrary to that, when the tension is too low, the process is hardly controlled. The peeling tension of from 90 to 170 N/m is more preferable.

(Stretching and Relaxing Process)

An example of mechanism of the tenter 4 is shown in FIG. 2. As is shown in FIG. 2, many clips 11 are connected in a chain form on the both sides of a housing 10 and the circles of chain of the clips are each run on rails 12 so that the film F is held and transported by the chain of the clips. The clip 11 has a swingable pressing arm, not shown in the drawing, and the film F is clipped at the both side edges between the curved end point of the pressing arm and a receiving stand so that the film is stretched and dried while transporting.

In the tenter 4, the cellulose ester film F is successively passed through a film width keeping zone A, a traversal direction stretching zone B, a zone C in which film width keeping in stretched state and a relaxing zone D while the film is held on the both side edges. Thus stretching in the traversal direction of the film is performed.

The width keeping zone A in the tenter 4 is a zoon of from the entrance of the tenter 4 to a stretch beginning point “a” in which the distance between the clips clipping the both edges of the film is constant. The stretching zone B is a zone from the stretching beginning point “a” to a stretching end point “b” in which the distance of the clips each clipping the both side edges is widen accompanied with the transportion of the film. The zone C in which film width keeping in stretched state is a zone from the stretching end point “b” to a relaxing beginning point “c” in which the distance between the clips clipping stretched film is constant.

The relaxing zone D is a zone of from the relaxation beginning point “c” to an relaxation end point “d” in which the distance between the clips is narrowed accompanied with the transportation of the film. In such the case, the relaxing treatment is a film holding pattern so as to narrow the width of the film, in which the is not tighten in the traversal direction namely no tension is applied in the traversal direction. The relaxing treatment is carried out while holding at the edge portions of the film.

The rails 12 in the tenter 4 is usually made flexible, and the distance of the clip of right side to that of left side is varied according to the curve of the rails so that the film width keeping zone A, the stretching zone B, the width keeping zone C and the relaxing zone D while are constituted. The stretching zone B and the relaxing zone C each corresponds to the stretching process and the relaxing process of the invention, respectively. The combination of these zones is not limited to that shown in the drawing and a combination of them in any order may be used.

Though the tenter 4 shown in the drawings is a clip tenter, a pin type tenter is also usable. It is preferable for improving the dimensional stability of the film that the film F is dried while keeping the width of the film by the tenter system irrespective of the type of tenter.

In the embodiment of the invention, the stretching ratio in the traversal direction is preferably set at a value of from 1 to 12%. The stretching ratio is more preferably from 3 to 9%. The stretching ratio is defined as follows.
Stretching ratio=(L₁/L₀−1)×100%
in the above:

L₁: The width of the film at the exit of the stretching zone

L₀: The width of the film at the entrance of the stretching zone
Relaxing ratio=(M₁/M₀−1)×100%
in the above,

M₁: The width of the film at the exit of the relaxing zone

L₀: The width of the film at the entrance of the relaxing zone.

In the stretching and relaxing zones, the temperature, hereinafter referred to as stretching temperature, is held within the range of from 110 to 160° C. The stretching temperature of from 115 to 150° C. is more preferable.

The amount of remaining solvent at the beginning of the stretching process, hereinafter referred to as remaining solvent amount for stretching, is within the range of from 10 to 40%. The remaining solvent amount for stretching of from 15 to 30% is more preferable.

(Drying Process)

The film F is introduced into the drying apparatus 5 after passed through the stretching, process. In the drying process 5, the film is transported by a hanging system via all transporting rollers 6 arranged in stagger and dried by drying air blown through the blowing opening 7 while transporting to obtain the cellulose ester film F. There is no limitation on the means for drying the film F, and hot air, infrared rays, heating roller or micro waves are usually applied. The hot air is preferably from the point of simplicity. The major object of the drying is to evaporate the remaining solvent and the temperature for drying, hereinafter referred to as drying temperature, is preferably from. 100° C. to 150° C. and the time for drying, hereinafter referred to as drying time, is preferably from 6 to 30 minutes. The retardation can be further lowered in the drying process. The drying temperature of from 115 to 140° C. and the drying time of from 10 to 25 minutes are more preferable.

### EXAMPLES

Examples 1 to 9 and Comparative example 1 and 2 are described below, but the invention is not limited to the examples.

Though Examples 1 to 9 and Comparative example 1 and 2 were different from each other in the producing conditions thereof, the same dope was commonly used. Concrete receipt of the dope is given in Table 1.

TABLE 1

| | Material | Amount |
|---|---|---|
| Cellulose ester | Cellulose acetate (Acetylated | 85 parts |
| | degree: 2.88) | by weight |
| Retardation | Methyl acrylate polymer | 5 parts |
| reducing agent | (Molecular weight: 1,000) | by weight |
| | Methyl methacrylate/hydroxyethyl | 10 parts |
| | acrylate copolymer (Weight ratio | by weight |
| | 80/20, molecular weight: 8,000) | |
| UV absorbent | 2-(2′-hydroxy-3′,5′-di-t- | 1.5 parts |
| | butylphenyl)benzotriazole | by weight |
| Solvent | Methylene chloride | 475 parts |
| | | by weight |
| | Ethanol | 50 parts |
| | | by weight |

Cellulose ester films of Examples 1 to 9 and Comparative example 1 and 2 were each prepared from the dope according to the conditions listed in Tables 2 and 3. In Table 3, the thickness of Cellulose ester films of Examples 1 to 9 and Comparative example 1 and 2 after dried are also listed.

TABLE 2

| | | | | Remaining | | Remaining | | | |
|---|---|---|---|---|---|---|---|---|---|
| | | | | solvent | Peeling | solvent | Stretching | | |
| | | | Drying | amount at | tension | amount at | temperature | Stretching | Relaxing |
| | MD + TD | MD − TD | rate | peeling | (N/m) | stretching | (C. °) | ratio | ratio |
| Example 1 | −8 | −3 | 4 | 110 | 100 | 25 | 130 | 5 | 2 |
| Example 2 | −8 | −3 | 4 | 110 | 100 | 25 | 105 | 5 | 2 |
| Example 3 | −7 | −1 | 3 | 100 | 100 | 15 | 130 | 4 | 2 |
| Example 4 | −7 | −1 | 3 | 100 | 100 | 15 | 105 | 4 | 2 |
| Example 5 | −20 | −10 | 5 | 125 | 90 | 30 | 110 | 1 | 1 |
| Example 6 | −15 | −10 | 2 | 115 | 80 | 40 | 115 | 3 | 2 |
| Example 7 | −5 | −5 | 3 | 110 | 100 | 15 | 150 | 9 | 5 |
| Example 8 | 0 | 5 | 4.5 | 110 | 100 | 10 | 160 | 12 | 6 |
| Example 9 | 0 | 10 | 4.5 | 110 | 100 | 25 | 160 | 12 | 2 |
| Comparative | 10 | 12 | 1 | 110 | 210 | 25 | 105 | 13 | 2 |
| example 1 | | | | | | | | | |
| Comparative | −25 | −20 | 1 | 110 | 210 | 25 | 105 | 13 | 2 |
| example 2 | | | | | | | | | |

TABLE 3

| | Post- | | | | |
|---|---|---|---|---|---|
| | drying | Post- | | | |
| | temper- | drying | Layer | | Retardation |
| | ature | time | thick- | Retardation | in thickness |
| | (C. °) | (Minute) | ness | in plane | direction |
| Example 1 | 130 | 20 | 80 | 0 nm | 1 nm |
| Example 2 | 100 | 20 | 80 | 0 nm | 1 nm |
| Example 3 | 130 | 15 | 40 | 0 nm | 2 nm |
| Example 4 | 100 | 15 | 40 | 0 nm | 2 nm |
| Example 5 | 105 | 25 | 80 | 1 nm | −3 nm |
| Example 6 | 115 | 25 | 82 | 1 nm | −2 nm |
| Example 7 | 140 | 25 | 40 | 0 nm | 2 nm |
| Example 8 | 150 | 25 | 40 | 0 nm | 3 nm |
| Example 9 | 150 | 25 | 40 | 1 nm | 3 nm |
| Comparative | 100 | 20 | 80 | 4 nm | 10 nm |
| example 1 | | | | | |
| Comparative | 100 | 20 | 80 | 7 nm | −5 nm |
| example 2 | | | | | |

The retardation in plane R₀ and that in thickness direction Rₜ of each of cellulose ester films of Examples 1 to 9 and Comparative example 1 and 2 were measured and listed in Table 3.

The R₀ and Rₜ were each calculated according to the following expressions.
R₀=(Nₓ−N_{y})×d
Rₜ={(Nₓ+N_{y})/2−N_{z}}×d
In the above:

Nₓ: Refractive index in slow axis direction

N_{y}: Refractive index in fast axis direction

N_{z}: Refractive index in thickness direction

d: Thickness of film (nm)

Nₓ, N_{y} and N_{z} were measured at a wavelength of 950 nm by an automatic double refractive index KOBRA-21ADH, manufactured by Ootsuka Keisokukiki Co., Ltd., in the atmosphere of 23° C. and 55% RH.

The results of Examples 1 to 9 each satisfied the relation of R₀=0 nm and −3 nm≦Rₜ≦3 nm. Therefore, the light leaking in the oblique direction can be considerably reduced and an image of high contrast can be obtained in wide viewing angle when the films of Examples 1 to 9 is used on the liquid crystal side of the polarizing plate of the display driven in the IPS mode.

In Comparative example 1, the stretching/shrinking ratio of MD+TD was 10%; such the result was an example of excessively high stretching ratio. The retardation of the film of Comparative example 1 was measured in the same manner as in Examples 1 to 9. According to the measured results, R₀ was 4 nm and Rₜ was 10 nm; such the results were also excessively large. Further, in Comparative example 2, the stretching/shrinking ratio of MD+TD was −25%; such the result was an example of excessively low stretching ratio. As a result, R₀ was 7 nm and Rₜ was −5 nm; such the results were also excessively large.

What is claimed is:

1. A method of producing a cellulose ester film, comprising:
a casting process of casting a dope containing a cellulose ester and an additive for reducing a retardation onto a support to form the film,
a peeling process of peeling the film from the support,
a stretching process of stretching the peeled film by a tenter,
a post-drying process of drying the stretched film and
a winding-up process of winding up the dried film,
wherein a stretching/shrinking ratio (%) of the film in a transporting direction MD and a stretching/shrinking ratio (%) of the film in a traversal direction TD are satisfy the following relation in the course after peeling the film from the support until winding up the film;
−20%≦MD+TD≦0%,
where MD and TD are represented by the following expression:
MD=(Transporting rate at the time of winding up/Transporting rate on the support−1)×100%
TD=(Film width at the time of winding up/Film width just before peeling from the support−1)×100%.

2. The producing method of claim 1, wherein the MD and TD satisfy the following relation;
−10%≦MD−TD≦10%.

3. The producing method of claim 1, wherein the MD and TD satisfy the following relation;
−5%≦MD≦5%, and −5%≦TD≦5%.

4. The producing method of claim 1, wherein the stretching/shrinking ratio in percent of the film in the transporting direction MD and that of the film in the traversal direction TD are adjusted to satisfy the following relation;
0≦R₀≦3, and −3≦Rₜ≦3
where R₀ represents a in-plane retardation (nm) of the cellulose ester film, and Rt represents a width direction retardation (nm) of the cellulose ester film.

5. The producing method of claim 1, wherein the reducing rate of remaining solvent is from 2 to 5% per second when the amount of the remaining solvent in the film on the support is lowered from 400% to 100%.

6. The producing method of claim 1, wherein the amount of solvent remaining in the film at the time of peeling off of the film from the support is from 60 to 125%.

7. The producing method of claim 1, wherein the tension applied for peeling off the film from the support is from 80 to 200 N/m.

8. The producing method of claim 1, wherein the amount of the remaining solvent at the time of beginning the stretching is from 10 to 40%.

9. The producing method of claim 1, wherein a temperature at the stretching step is from 110 to 160° C. and a stretching ratio of the film is from 1 to 12%.

10. The producing method of claim 9, further comprising a relaxing process of relaxing the film and a relaxing ratio of the film in the relaxing step is from 1 to 6%.

11. The producing method of claim 1, wherein a temperature and a drying time in the post-drying step are each from 100 to 150° C. and from 6 to 30 minutes, respectively.

12. The producing method of claim 1, wherein the additive contains an acryl type polymer having a weight average molecular weight of from 500 to less than 30,000.

13. The producing method of claim 12, wherein the additive contains the acryl type polymer having a weight average molecular weight of from 5,000 to less than 30,000.

14. The producing method of claim 1, wherein-the cellulose ester film has a thickness of from 35 to 85 μm.

15. A liquid crystal display apparatus, comprising:
a liquid crystal cell including a liquid crystal layer and a pair of base boards sandwiching the liquid crystal layer and driven in an IPS mode; and
a pair of polarizing plates arranged on both sides of the liquid crystal cell on a condition crossing at right angle, wherein the cellulose ester film produced by the method described in claim 1 is provided at the liquid crystal cell side of at least one of the polarizing plates.
